(19) United States
(12) Patent Application Publication
(10) Pub. No.: US 2011/0072420 A1
(43) Pub. Date: Mar. 24, 2011

(54) APPARATUS AND METHOD FOR CONTROLLING PARALLEL PROGRAMMING

(75) Inventors: Byung-Chang CHA, Gimpo-si (KR); Sung-Do Moon, Seongnam-si (KR); Jung-Gyu Park, Yongin-si (KR); Dae-Hyun Cho, Suwon-si (KR)

(73) Assignee: SAMSUNG ELECTRONICS CO., LTD., Suwon-si (KR)

(21) Appl. No.: 12/842,571

(22) Filed: Jul. 23, 2010

(30) Foreign Application Priority Data
Sep. 22, 2009 (KR) 10-2009-0089781

(51) Int. Cl. G06F 9/45

(52) U.S. Cl. 717/149

(57) ABSTRACT

A parallel programming adjusting apparatus and method are provided. Parameter sets are made by grouping parameters of a parallel programming model influencing the system performance, the parameter sets are combined among the groups, generating parameter combinations. Execution files are executed for the individual parameter combinations and a runtime of a parallel region for respective parameter combination is measured. An optimum parameter combination is selected based on the measured runtime.

### CROSS-REFERENCE TO RELATED APPLICATION(S)

This application claims the benefit under 35 U.S.C. §119(a) of Korean Patent Application No. 10-2009-0089781, filed on Sep. 22, 2009, the disclosure of which is incorporated herein by reference in its entirety for all purposes.

### BACKGROUND

1. Field

The following description relates to a parallel programming model used in a multi core architecture.

2. Description of the Related Art

The system performance of a single core system has been improved in a specific way to increase operation speed, that is, by increasing clock frequency. However, the increased operation speed causes high power consumption and a substantial amount of heat production, and there are limitations to increasing operation speed in order to improve performance.

In recent years, multi-core systems which use a plurality of a central processing units (CPUs) or cores has emerged and become popular. The multi-core system is widely used across many applications including televisions and mobile phones in addition to computers.

Each core processes a predetermined job in a parallel manner while operating independent of each other, thereby improving the performance of system. Parallel processing of some sort is common among such multi-core systems. A parallel programming model is a programming scheme enabling processes within a program to run concurrently and is used to develop a program for a multi-core system.

OpenMp is one of the representative parallel programming models. OpenMP allows a predetermined block of code to serve as a multi-thread through a simple directive. Conventionally, most compilers, for example, GNU compiler collection (gcc), Intel Compiler, Microsoft visual studio, etc. support OpenMP directives.

FIG. 1 shows an example of a parallel programming model.

As shown in FIG. 1, a parallel programming model may be OpenMP. OpenMP is a parallel programming structure allowing a predetermined part 102 of code to serve as a multi-thread through a predetermined directive 101. For example, as shown in FIG. 1, a predetermined code is compiled and an execution result is provided in which one or more texts “hello” may be displayed depending on the system. The number of times the text “hello” is displayed is determined based on the physical number of central processing units (CPU) or CPU cores in a system. That is, OpenMp enables a required number of threads for the parallel processing region 102 to correspond to the number of CPUs or CPU cores in a system.

In FIG. 1, OpenMp has been described as a programming model to which the example is applied but the example is not limited thereto. The example may be applicable to programming models such as OpenCL, TBB (threading building blocks), Cilk, etc.

As described above, the parallel programming model is mainly used in a multi-core system, and various parameters of programming need to be controlled for different system architectures. However, it is complicating for a programmer to manually search for the optimum environmental variable for all parallel regions of each system and it is impossible to search for all available cases.

### SUMMARY

In one general aspect, there is provided an apparatus for controlling parallel programming, the apparatus including: a combination generating unit configured to generate parameter combinations by: receiving parameter information about parameters of a parallel programming model, generating parameter groups using the received parameter information, and combining parameter sets among the generated parameter groups, a compiling unit configured to: instrument a time measurement function for measuring a runtime of a parallel region for the parallel programming model, and generate execution files for individual each generated parameter combinations, and a combination selection unit configured to select at least one of the generated parameter combinations by use of a profile representing each runtime of the parallel region for each parameter combination according to an execution result of the execution file, the each runtime being measured by the instrumented function.

The apparatus may include that the parameter information includes at least one of: a type of parameter, a range of settable parameter values, and group information among parameters.

The apparatus may include that the type of parameter includes at least one of: a number of threads, a scheduling method, a chunk size, and a central processing unit (CPU) affinity.

The apparatus may include that: the group information includes priority information among the parameter groups, and the combination generating unit is further configured to: set some of the parameter sets within the parameter group as a default, and generate the parameter combination.

The apparatus may include that the combination generating unit is further configured to: generate the parameter sets by setting individual parameter values for each generated parameter group, and remove a repeated parameter set from the generated parameter sets.

The apparatus may include that: the selected parameter combination is transferred to the compiling unit, and the compiling unit is further configured to generate a final execution file by use of the selected parameter combination.

In another general aspect, there is provided a method of controlling parallel programming, the method including: generating parameter combinations by: receiving parameter information about parameters of a parallel programming model, generating parameter groups using the received parameter information, and combining parameter sets among the generated parameter groups, instrumenting a time measurement function for measuring a runtime of a parallel region for the parallel programming model, generating execution files for individual generated parameter combinations, and selecting at least one of the generated parameter combinations by use of a profile representing each runtime of the parallel region for each parameter combination according to an execution result of the execution file, the each runtime being measured by the instrumented function.

The method may include that the parameter information includes at least one of: a type of parameter, a range of settable parameter values, and group information among parameters.

The method may include that the type of parameter includes at least one of: a number of threads, a scheduling method, a chunk size, and a central processing unit (CPU) affinity.

The method may include that: the group information includes priority information among the parameter groups, and the generating of the parameter combination includes setting some of the parameter sets within the parameter group as default and generating the parameter combination.

The method may include that the generating of the parameter combination includes: generating the parameter sets by setting individual parameter values for each generated parameter group, and removing a repeated parameter set from the generated parameter sets.

The method may further include generating a final execution file by use of the selected parameter combination.

In another general aspect, there is provided a computer-readable information storage medium including a method of controlling parallel programming, including: generating parameter combinations by: receiving parameter information about parameters of a parallel programming model, generating parameter groups using the received parameter information, and combining parameter sets among the generated parameter groups, instrumenting a time measurement function for measuring a runtime of a parallel region for the parallel programming model, and generating execution files for individual generated parameter combinations, selecting at least one of the generated parameter combinations by use of a profile representing each runtime of the parallel region for each parameter combination according to an execution result of the execution file, the each runtime being measured by the instrumented function.

The computer-readable information storage medium may include that the parameter information includes at least one of: a type of parameter, a range of settable parameter values, and group information among parameters.

The computer-readable information storage medium may include that the type of parameter includes at least one of: a number of threads, a scheduling method, a chunk size, and a central processing unit (CPU) affinity.

The computer-readable information storage medium may include that the generating of the parameter combination includes: generating the parameter sets by setting individual parameter values for each generated parameter group, and removing a repeated parameter set from the generated parameter sets.

The computer-readable information storage medium may include that: the group information includes priority information among the parameter groups, and the generating of the parameter combination includes setting some of the parameter sets within the parameter group as default and generating the parameter combination.

The computer-readable information storage medium may further include generating a final execution file by use of the selected parameter combination.

Other features and aspects will be apparent from the following detailed description, the drawings, and the claims.

### BRIEF DESCRIPTION OF THE DRAWINGS

FIG. 1 is an example of a parallel programming model.

FIG. 2 is an example of parameters of a parallel programming model.

FIG. 3 is an example of an apparatus for controlling parallel programming.

FIG. 4 is an example of parameter information.

FIG. 5 is an example of parameter combinations.

FIG. 6 is an example of a time measurement function.

FIG. 7 is an example of a profile.

FIG. 8 is an example of a method for controlling parallel programming.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein.

Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

Hereinafter, examples will be described with reference to accompanying drawings in detail.

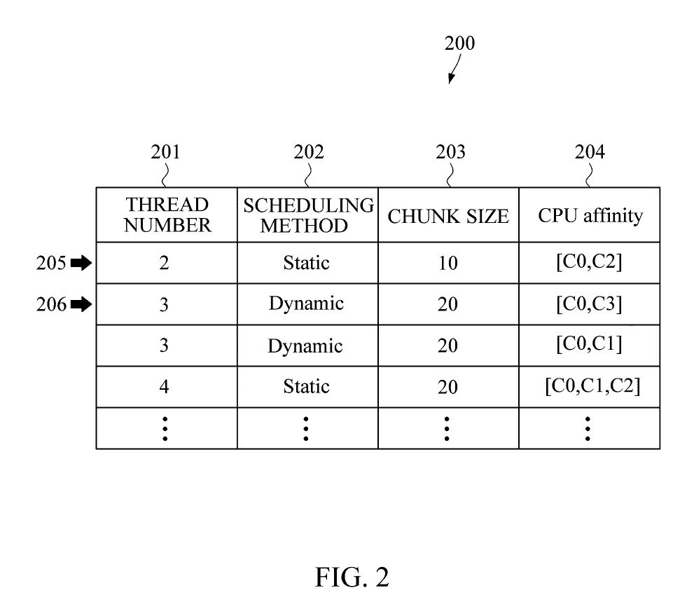

FIG. 2 shows an example of parameters of a parallel programming model.

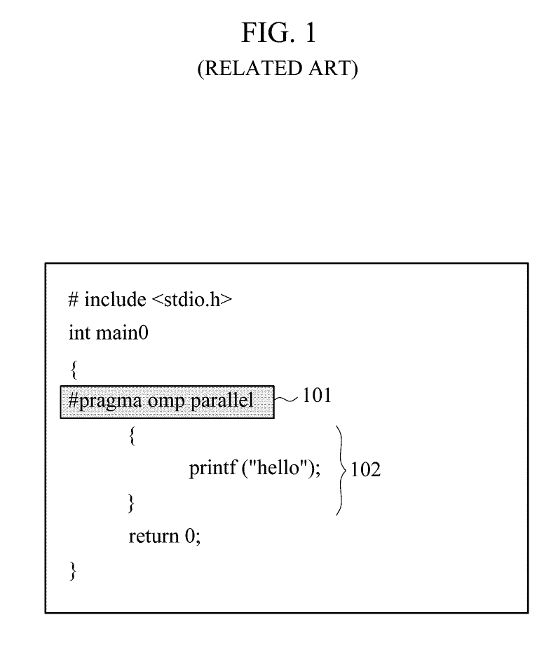

As shown in FIG. 2, parameters of a parallel programming model may be various environmental variables or option items capable of influencing the system performance. For OpenMP (see FIG. 1 above), a programmer may control a runtime of a parallel region by adding such a parameter to a part of code or OpenMP directive.

As shown in FIG. 2, the example of parameters 200 may include a thread number 201 indicating the number of threads generated corresponding to a parallel region, a scheduling method 202 indicating the scheduling type or scheduling scheme such as static scheduling and dynamic scheduling, a chunk size 203 indicating the size of chunk during scheduling, and a central processing unit (CPU) or core affinity 204 indicating each core to which the thread is assigned.

For example, reference number 205 may represent a parameter combination in which two threads are generated corresponding to a parallel region, a static scheduling is performed by assigning a size 10 chunk at the scheduling, and generated threads are assigned to core 0 and core 2. In addition, reference numeral 206 may represent a parameter combination in which three threads are generated corresponding to a parallel region, a dynamic scheduling is performed by assigning a size 20 chunk at the scheduling, and generated threads are assigned to core 0 and core 3.

Accordingly, the number of parameter combinations applicable to one parallel region may be expressed according to Equation 1:

N=the number of threads×the number of scheduling methods×the number of chunk sizes×the number of core affinities. [Equation 1]

For example, where the number of available threads 201 is 3; the number of available scheduling methods 202 is 2, e.g., static scheduling and dynamic scheduling; the number of available chunk sizes 203 is 2, e.g., 10 and 20; the number of available core affinities 204 is four, e.g., [C0], [C0, C1], [C0, C2], [C0, C1, C2]; using Equation 1, the number of possible parameter combinations is forty-eight (N=3×2×2×4=48). In addition, when the number of parallel regions is M, the entire parameter combinations is N^{M}. For the CPU affinity 204, C0 and C1 may represent an identifier or a core number of a core to which a thread is assigned.

According to the example of the parallel programming controlling apparatus, an optimum combination may be selected from various parameter combinations, improving the system performance. The optimum combination represents a parameter combination capable of reducing runtime of a parallel region.

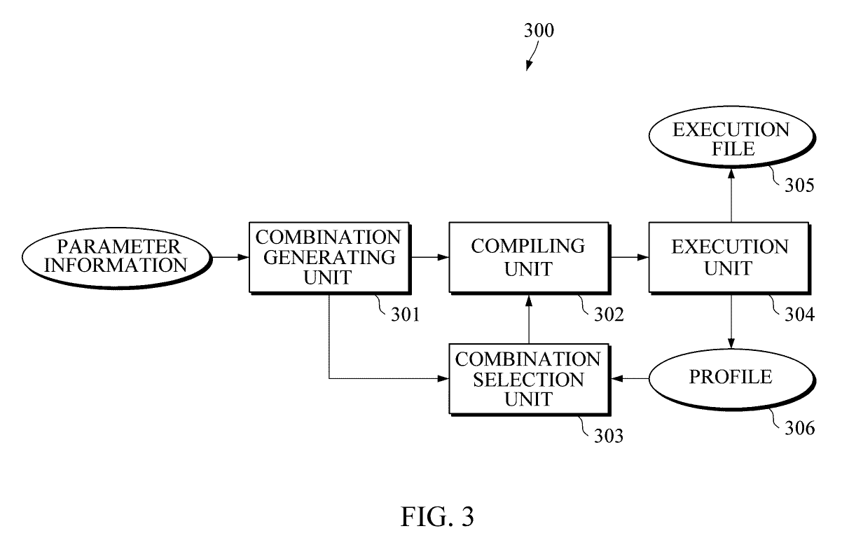

FIG. 3 shows an example of an apparatus for controlling parallel programming.

As shown in FIG. 3, a parallel programming controlling apparatus 300 may include a combination generating unit 301, a compiling unit 302, and a combination selection unit 303.

The combination generating unit 301 may generate a predetermined parameter group based on received parameter information. The parameter information may include at least one of a type of parameter, a range of settable parameter values, and group information among parameters. Such parameter information may be directly input by a user or input from a setting file created by a user. For example, the combination generating unit 301 may combine the thread number 201 and the CPU affinity 204 into one group, e.g., G1; and may combine the scheduling method 202 and the chunk size 203 into one group, e.g., G2. The grouping may be performed based on the type of parameters and the group information that are included in the parameter information.

In addition, the combination generating unit 301 may generate parameter sets by setting individual parameter values for each generated parameter group. For example, if the thread number 201 and the CPU affinity 204 are combined into one group, the combination generating unit 301 may generate a parameter set representing how many threads are generated and to which core each thread is assigned. The parameter values in the parameter set may be set based on the type of parameters and the range of parameter values that are included in the parameter information.

In addition, the combination generating unit 301 may generate parameter combinations by combining the parameter sets between the parameter groups. For example, if the group G1 has ten (10) parameter sets and the group G2 has five (5) parameter sets, fifty (50, e.g., 10×5) parameter combinations or fifteen (15, e.g., 10+5) parameter combinations may be generated. The detailed process of generating parameter combinations in the combination generating unit 301 will be described later.

The compiling unit 302 may instrument a function for measuring a runtime of a parallel region and may generate an execution file for each parameter combination.

The instrumentation of function (e.g., by the compiling unit 302) means that a predetermined function is inserted in a code or a call instruction of a predetermined function is inserted during a compiling process. The compiling unit 302 may insert a function, which records runtime of a corresponding point, into a start point and an end point of a parallel region.

Execution files generated by the compiling unit 302 may be executed for individual parameter combinations. For example, an execution unit 304 may execute the generated execution files for individual parameter combinations. That is, as an execution file are executed, an execution result 305 and a profile 306 may be generated. The profile 306 refers to a recording file which stores the execution time of a parallel region for each parameter combination, in which the execution time of the parallel region is measured by an instrumented function.

The combination selection unit 303 may analyze the generated profile 306 to select at least one parameter combination. For example, the combination selection unit 303 may select a parameter combination for a predetermined parallel region which produces the shortest runtime.

The selected parameter combination may be transferred to the compiling unit 302, and the compiling unit 302 may generate a final execution file based on the received parameter combination. Accordingly, a programmer may not need to manually control individual parameters, and an optimum parameter may be automatically set.

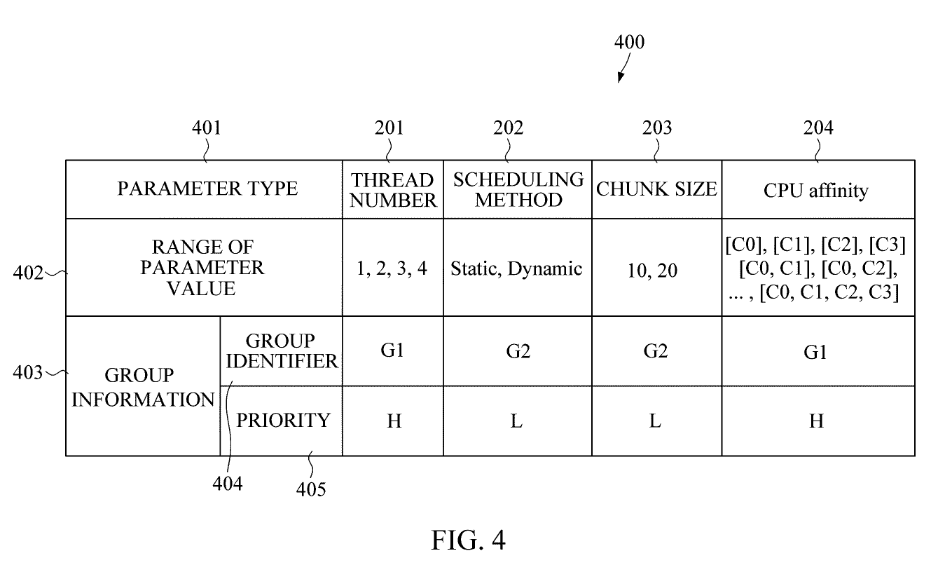

FIG. 4 shows an example of parameter information.

As shown in FIG. 4, parameter information 400 may include a type of parameters 401, a range of parameter values 402, and group information 403. Such parameter information 400 may be directly input by a user. Alternatively, after the combination generating unit 301 provides a programmer with a fundamental information input interface, the parameter information 400 may be obtained based on a setting file that is generated from information input by the programmer.

The available types of parameters 401 are similar to those described above with reference to FIG. 2.

The range of parameter values 402 may represent a state value available for individual parameters. For example, the thread number 201 may be possible in the range of 1 to 4, the number of available scheduling methods 202 may be two, e.g., a static scheduling and a dynamic scheduling; and the number of available chuck size 203 may be two, e.g., a chunk size of 10 and a chunk size of 20. Regarding CPU affinity 204, when two threads are present, [C0, C1]represents that threads are assigned to core 0 and core 1, respectively; and [C0, C2] represents that threads are assigned to core 0 and core 2, respectively.

The group information 403 may include a group identifier 404 and a priority 405. The group identifier 404 indicates parameters grouped into a predetermined group and the priority 405 represents the priority among groups. For example, an identifier of group G1 may be assigned to the thread number 201 and the CPU affinity 204, and an identifier of group G2 may be assigned to the scheduling method 202 and the chunk size 203. In addition, group G1 may have a higher priority to group G2.

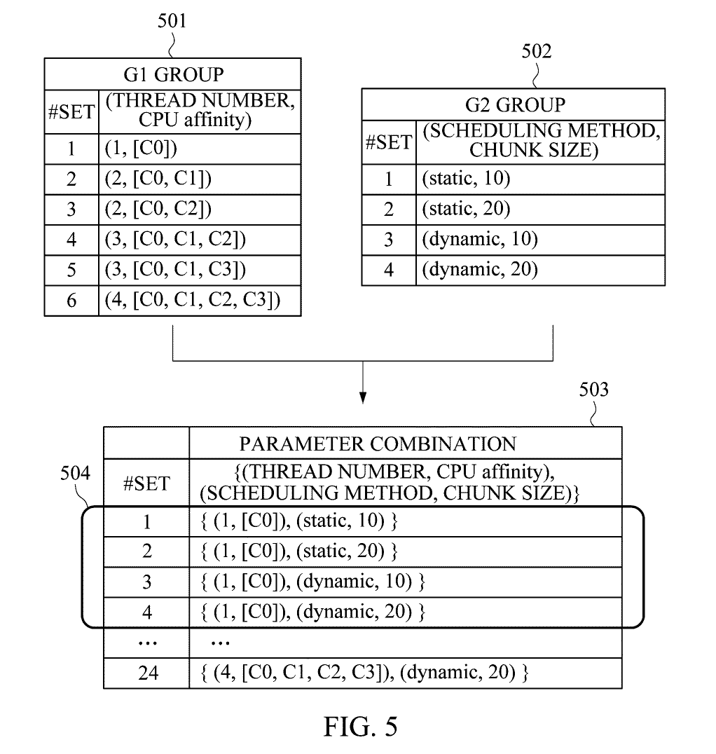

FIG. 5 shows an example of parameter combinations.

A method of generating a parameter combination in the combination generating unit 301 will be described with reference to FIG. 5.

The combination generating unit 301 may generate parameter groups by use of parameter information shown in FIG. 4. For example, a group G1 501 and a group G2 502 may be generated by use of the group information 403, shown in FIG. 4.

The combination generating unit 301 may generate parameter sets by setting individual parameter values for each parameter group. For example, when the group G1 501 is viewed, six parameter sets may be generated by setting the number of generated threads and which core is assigned each thread by use of the range of parameter values 402 shown in FIG. 4. In addition, the six parameter sets may be obtained by removing repeated parameter sets from the generated parameter sets. The repeated parameter set represents a parameter set causing the same parallel processing time. In an example in which one thread is available in the group G1 501, the core selection may not significantly affect the system performance, and thus three of the group including (1,[C0]), (1,[C1]), (1,[C2]), and (1,[C3]) may be regarded as the repeated parameter sets. Accordingly, the combination generating unit 301 may remove, for example, (1,[C1]), (1,[C2]), and (1,[C3]) from the generated parameter sets (1,[C0]), (1,[C1]) (1,[C2]), and (1,[C3]), leaving only (1,[C0]). It should be appreciated that any one of the repeated parameter sets may be retained.

The combination generating unit 301 may combine the parameter sets among the parameter groups, generating parameter combinations 503. For example, the combination generating unit 301 may generate parameter sets 504 by combining a parameter set 1 of the group G1 501 with parameter sets 1 to 4 of the group G2 502. In this case, the total number of parameter combinations is twenty-four (24, e.g., 6×4).

In addition, the combination generating unit 301 may set some parameter sets within a predetermined group as default by use of the priority among groups and generate parameter combinations. For example, if the group G2 502 has a priority lower than that of the group G1501, the group G2 502 having a lower priority may be set as a default, six parameter combinations may be generated for the group G1 501 having the higher priority, and parameter combinations for the group G2 502 may be generated based on the parameter combinations generated for the group G1 501. In this example, the total number of generated parameter combinations may be ten (10, e.g., 6+4).

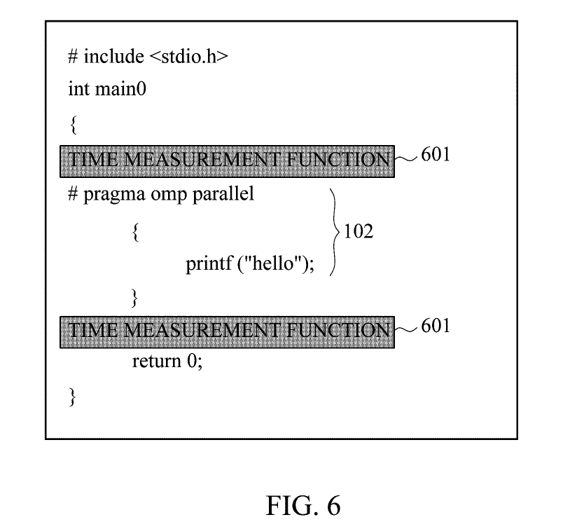

FIG. 6 shows an example of a time measuring function.

As shown in FIG. 6, a time measurement function 601 is a function of generating a profile that records runtime of a predetermined part of code. Such a time measurement function 601 may be provided as an application programming interface (API). When generating an execution file, the compiling unit 302 may insert such a time measurement function 601 or a call instruction for the time measurement function 601 at the beginning and/or end points a parallel region. Such an inserting process is referred to as instrumentation of the time measurement function 601.

In this manner, as the execution file is executed after compiling, the time measurement function may record or measure the runtime of a parallel region for each parameter combination. Each runtime may be displayed as a profile result.

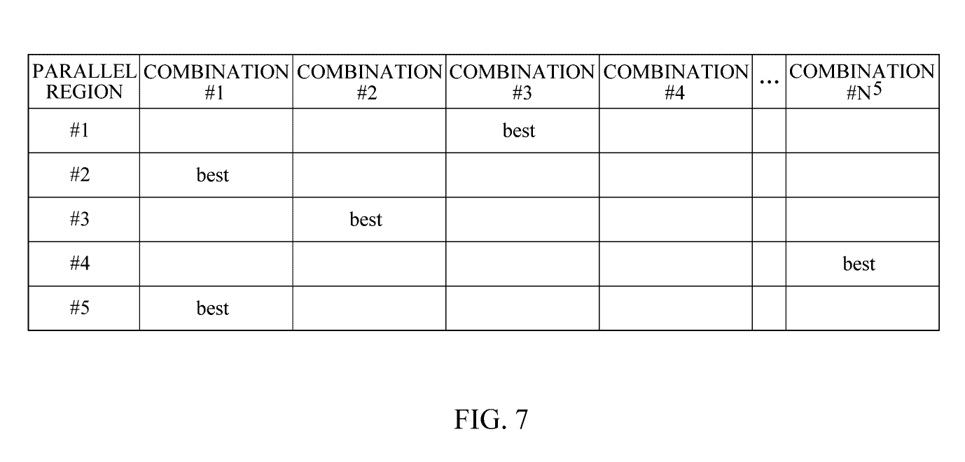

FIG. 7 shows an example of a profile.

The profile shown in FIG. 7 represents the runtime of each parallel region for each parameter combination. For example, in FIG. 7, parallel regions #2 and #5 may produce the shortest runtime when parameter combination #1 is used, and parallel region #1 may produce the shortest runtime when parameter combination #3 is used.

The combination selection unit 303 may select a parameter combination allowing the shortest runtime for each parallel region by use of such a profile. The selected parameter combination may be transferred to the compiling unit 302 which may create a final execution file by use of the selected parameter combination.

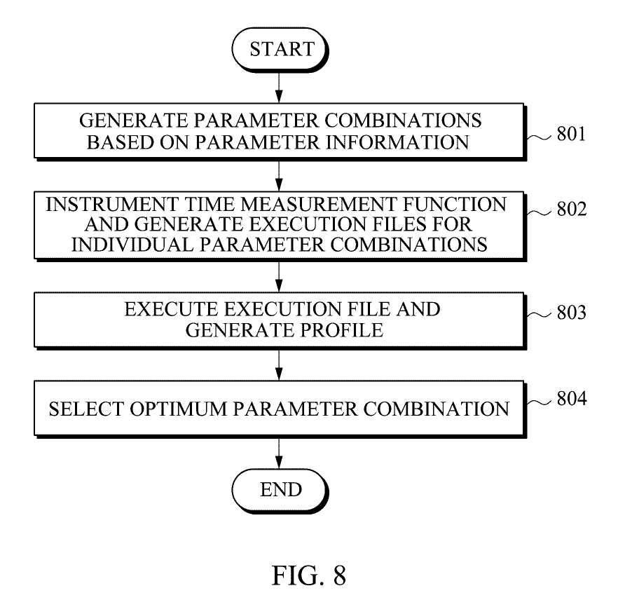

FIG. 8 shows an example of a method for controlling parallel programming.

As shown in FIG. 8, in operation 801, parameter combinations may be generated by receiving parameter information about a parallel programming model, generating parameter groups using the received parameter information, and combining parameter sets among the generated parameter groups. For example, the combination generating unit 301 may generate parameter combinations shown in FIG. 5 by receiving the parameter information shown in FIG. 4 from a user.

In operation 802, a time measurement function for measuring runtime of a parallel region may be instrumented and execution file for individual parameter combinations may be generated. For example, the compiling unit 302 may perform compiling by inserting the time measurement function (see 601 in FIG. 6) at the beginning and end points the parallel region.

In operation 803, the execution files generated for individual parameter combinations may be executed, generating a profile. For example, the execution unit 304 may generate a profile shown in FIG. 7 by executing the instrumented time measurement function (see, for example, operation 601 in FIG. 6).

In operation 804, an optimum parameter combination may be selected by use of the generated profile. The combination selection unit 303 may select a parameter combination enabling the shortened processing time for each parallel region with reference to the profile shown in FIG. 7.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the computing system or a computer described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, and devices such as a desktop PC, a high definition television (HDTV), an optical disc player, a setup box, and the like.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling parallel programming, the apparatus comprising:
a combination generating unit configured to generate parameter combinations by:
receiving parameter information about parameters of a parallel programming model;
generating parameter groups using the received parameter information; and
combining parameter sets among the generated parameter groups; a compiling unit configured to:
instrument a time measurement function for measuring a runtime of a parallel region for the parallel programming model; and
generate execution files for individual each generated parameter combinations; and
a combination selection unit configured to select at least one of the generated parameter combinations by use of a profile representing each runtime of the parallel region for each parameter combination according to an execution result of the execution file, the each runtime being measured by the instrumented function.

2. The apparatus of claim 1, wherein the parameter information comprises at least one of: a type of parameter, a range of settable parameter values, and group information among parameters.

3. The apparatus of claim 2, wherein the type of parameter comprises at least one of: a number of threads, a scheduling method, a chunk size, and a central processing unit (CPU) affinity.

4. The apparatus of claim 2, wherein:
the group information comprises priority information among the parameter groups; and
the combination generating unit is further configured to:
set some of the parameter sets within the parameter group as a default; and
generate the parameter combination.

5. The apparatus of claim 1, wherein the combination generating unit is further configured to:
generate the parameter sets by setting individual parameter values for each generated parameter group; and
remove a repeated parameter set from the generated parameter sets.

6. The apparatus of claim 1, wherein:
the selected parameter combination is transferred to the compiling unit; and
is the compiling unit is further configured to generate a final execution file by use of the selected parameter combination.

7. A method of controlling parallel programming, the method comprising:
generating parameter combinations by:
receiving parameter information about parameters of a parallel programming model;
generating parameter groups using the received parameter information; and
combining parameter sets among the generated parameter groups;
instrumenting a time measurement function for measuring a runtime of a parallel region for the parallel programming model;
generating execution files for individual generated parameter combinations; and
selecting at least one of the generated parameter combinations by use of a profile representing each runtime of the parallel region for each parameter combination according to an execution result of the execution file, the each runtime being measured by the instrumented function.

8. The method of claim 7, wherein the parameter information comprises at least one of: a type of parameter, a range of settable parameter values, and group information among parameters.

9. The method of claim 8, wherein the type of parameter comprises at least one of: a number of threads, a scheduling method, a chunk size, and a central processing unit (CPU) affinity.

10. The method of claim 8, wherein:
the group information comprises priority information among the parameter groups; and
the generating of the parameter combination comprises setting some of the parameter sets within the parameter group as default and generating the parameter combination.

11. The method of claim 7, wherein the generating of the parameter combination comprises:
generating the parameter sets by setting individual parameter values for each generated parameter group; and
removing a repeated parameter set from the generated parameter sets.

12. The method of claim 7, further comprising generating a final execution file by use of the selected parameter combination.

13. A computer-readable information storage medium comprising a method of controlling parallel programming, comprising:
generating parameter combinations by:
receiving parameter information about parameters of a parallel programming model;
generating parameter groups using the received parameter information; and
combining parameter sets among the generated parameter groups;
instrumenting a time measurement function for measuring a runtime of a parallel region for the parallel programming model; and
generating execution files for individual generated parameter combinations;
selecting at least one of the generated parameter combinations by use of a profile representing each runtime of the parallel region for each parameter combination according to an execution result of the execution file, the each runtime being measured by the instrumented function.

14. The computer-readable information storage medium of claim 13, wherein the parameter information comprises at least one of: a type of parameter, a range of settable parameter values, and group information among parameters.

15. The computer-readable information storage medium of claim 14, wherein the type of parameter comprises at least one of: a number of threads, a scheduling method, a chunk size, and a central processing unit (CPU) affinity.

16. The computer-readable information storage medium of claim 13, wherein the generating of the parameter combination comprises:
generating the parameter sets by setting individual parameter values for each generated parameter group; and
removing a repeated parameter set from the generated parameter sets.

17. The computer-readable information storage medium of claim 15, wherein:
the group information comprises priority information among the parameter groups; and
the generating of the parameter combination comprises setting some of the parameter sets within the parameter group as default and generating the parameter combination.

18. The computer-readable information storage medium of claim 13, further comprising generating a final execution file by use of the selected parameter combination.
